(19) United States
(12) Patent Application Publication
(10) Pub. No.: US 2008/0208671 A1
(43) Pub. Date: Aug. 28, 2008

(54) SYSTEM AND METHOD FOR MATCHING PEOPLE AND JOBS USING SOCIAL NETWORK METRICS

(76) Inventors: Kate Ehrlich, Newton, MA (US); Robert George Farrell, Cornwall, NY (US); Mary Elizabeth Helander, North White Plains, NY (US); Michael Sidney Karasick, Austin, TX (US)

Correspondence Address: Whitham, Curtis, & Christofferson, P.C., Suite 340, 11491 Sunset Hills Road, Reston, VA, 20190, US

(21) Appl. No.: 11/680,039

(22) Filed: Feb. 28, 2007

(51) Int. Cl. G06Q 10/00

(52) U.S. Cl. 705/9

(57) ABSTRACT

A computer-implement method and the associated system of computing resources provides an automated work force management capability that optimizes work assignments for individual workers using work force management techniques in combination with social networking analysis (SNA). The work force management attributes are enhanced using SNA. Bipartite graphing processes are used to match the socially enhance worker attributes with the work requirements. By combining the social networking information with the work force management attributes, work assignments are optimized. This optimization exploits historical social interactions between workers and combines their influence with the skills and other work force attributes of each worker required for job performance.

### BACKGROUND OF THE INVENTION

1. Field of the Invention

The present invention generally relates to a system and method for matching people and jobs using social metrics and, more particularly, to a system and method that considers both the social attributes of a worker together with the skills of the worker to optimize the allocation of workers to jobs using bipartite graphs and social network analysis techniques.

2. Background Description

A social network is a structure made of nodes or vertices which are generally individuals or organizations and links or edges between them. Edges represent relationships or connections between the elements of the network. Each of the nodes or links may have various attributes. The term, social network, was first coined in 1954 by Barnes, J.in. Class and Committees in a Norwegian Island Parish. Human Relations, 7, 39-58. Social Network Analysis (SNA) has emerged as an important technique in modern sociology, as well as anthropology, social psychology and organizational studies. SNA is a set of methods and metrics that shows how people collaborate including patterns of communications, information-sharing, decision-making or innovation within a particular group or organization. Social networking contends that relationships and ties with other actors within the network can be more important than the attributes of each individual. Social network metrics are measures of social networks or calculations based on these measures.

Work management tries to optimize business objectives when matching a set of employees to a set of jobs. Employees have attributes such as skills. Jobs have requirements for these attributes, such as required skills.

In graph theory, a bipartite graph is a graph where the set of vertices can be divided into two disjoint sets U and V such that no edge has both end points in the same set. Bipartite graphs are often used for modeling matching problems. A bipartite graph with weights on the edges is a weighted bipartite graph. One common matching problem is the assignment problem, finding a maximum weight matching in a weighted bipartite graph. There are several well-known algorithms for solving the assignment problem.

Social psychology has indicated that teams work more effectively when prior working relationships are exploited. While traditional work management methodologies have been able to match available skills with required skills, there has not been an automated ability that considers the social network together with the particular skills in order to maximize the productivity of the ultimate staffing of jobs.

### SUMMARY OF THE INVENTION

It is therefore an exemplary embodiment of the present invention to provide work assignments of individual workers using an automated methodology which combines the worker attributes and job requirements of workforce management with the relationship metrics of social networking using bipartite graphs.

According to the invention, there is provided a method and related system for analyzing the work history of workers to determine a social network in terms of which workers have worked together previously. The methodology could be configured to use past working relationships on any one of several criteria such as hours worked together, projects successfully completed together as defined by client surveys or other commonly used management measurement tools. In an alternate embodiment, the method can be configured to use the history of communications between workers to construct the social network. In another alternate embodiment, the method can be configured to use the number of documents or other digital or non-digital artifacts authored or constructed together. These social networks would be analyzed to create a metric. Common metrics in social network analysis include betweenness, centrality, cohesion, density. The method uses metrics that apply to individual nodes (workers) in the social network (as opposed to the network as a whole). The metric is computed for each worker, and is applied to the attributes of the workers to create a socially enhanced set of attributes for each worker. Once the worker attributes are enhanced with the results of social network analysis, a bipartite graph is built and weights applied to each of the links. The weights are used to match the workers with the particular jobs. The match is then used to assign a worker to each job.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a high level flow diagram of the steps of the matching method.

FIG. 2A is an example of a social network analysis which considers hours worked together.

FIG. 2B is an example of a social network analysis which considers documents prepared together.

FIG. 3 is an example of work force management attributes.

FIG. 4 is an example of the bipartite graph used to make a work assignment.

FIG. 5 is a system configuration diagram of the computer resources for the invention.

### DETAILED DESCRIPTION OF THE PREFERRED EMBODIMENTS OF THE INVENTION

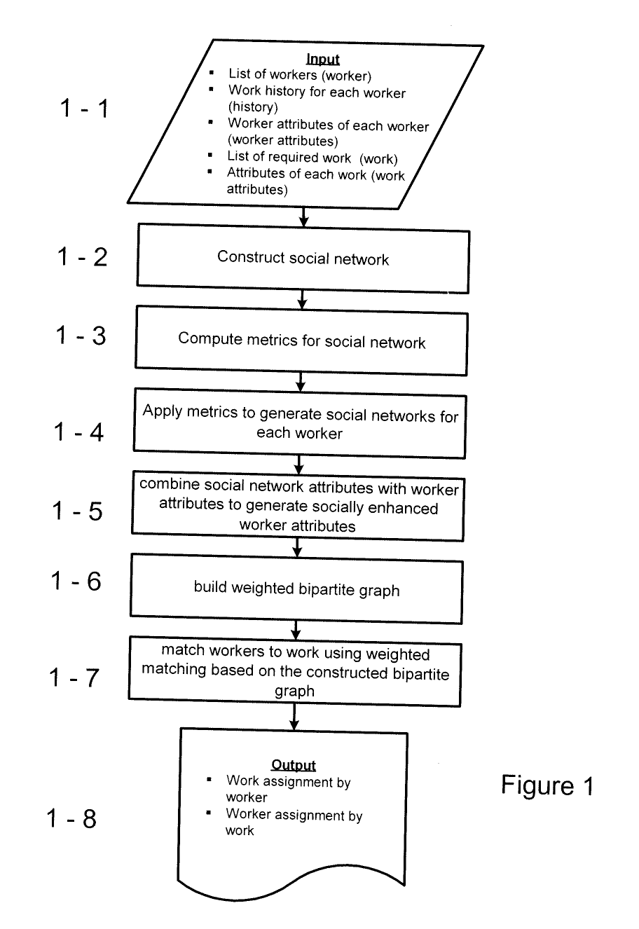

Referring now to the drawings, and more particularly to FIG. 1, there is shown a flow chart that describes a computer-implemented method for assigning people to specific jobs. Numerous types of input data (1-1) can be processed by the invention to create the work assignments. These inputs (1-1) include but are not limited to at least one of the following:
List of workers (for the purposes of this invention referred to as worker),
Work history for each worker (for the purposes of this invention referred to as work history),
Worker attributes (for the purposes of this invention referred to as worker attributes),
List of required work (for the purposes of this invention referred to as jobs), and
Attributes of each work (for the purposes of this invention referred to as job attributes).
   The types of data that would be considered work history could include number of hours each worker spent working with another worker or number of documents written jointly between two workers. Other data could be used that would be derived from customer (client) surveys, job performance reviews, or the like that quantify the social relationships between worker pairs. The types of data that would be considered worker attributes are those technical and management skills that an individual possesses (e.g., a workers level of skill in JAVA, C++ or other software applications). In addition, a workers level of skill in areas such as program management, systems management, systems architecture, communications design, accounting, etc. could be part of the input.

The input data base may be received from one or more databases and/or may be entered manually by a user of the system or some combination of the two. That is, a user who desires work assignment recommendations could enter specific requirements of a job (work attributes) and then request the method access database to obtain information for all workers available within the organization.

Once the data is received, the invention constructs the social network (1-2). The construction of the social network is using traditional social network analytics that analyze the work history information and constructs the topology of the social network. From this network topology, social networks metrics are computed (1-3). Metrics which are typically computed from the topology deal with centrality, that is, how central an individual is to an organization, project or other social structures. The system can identify a general centrality metric or can use more detail levels of centrality such as but not limited to, Degree, Betweenness, Closeness, and Flow centrality. These terms are commonly used in the art of social network analysis and are easily understood by those skilled in the art of social network analysis.

Once the centrality (or other metrics) has been computed, these metrics are applied (1-3) to each of the individual workers being considered by the invention for possible work assignment. The social network metrics are combined with the worker attributes to generate the socially enhanced worker attributes (1-5). Using the work history, the work attributes and the socially enhanced worker attributes, a bipartite graph is built which weights each of the possible links between workers and jobs (1-6). These weights can be defined by the system user during the initiation of the work assignment process or can be generated automatically by the system from the analysis of the data. The weights can relate to thresholds set for specific job requirements giving higher weight to those links that more closely fit the specific job attributes. The Hungarian Method is an example of an algorithm that solves (in polynomial time) the assignment problem for a complete, bipartite graph. Other algorithm exist that can also be used including but not limited to a general weighted matching method by Edmunds.

Finally the workers are matched to the particular jobs (1-7). The workers are assigned to a job using the weights on the constructed bipartite graph. These weights can be calculated using several different factors such as, but not limited to, the closeness of each workers attributes to the work attributes. The calculation of the weights may also include threshold levels set by the user of the system. Once the matching is performed a report is outputted (1-8) to the user. The format for the output may include but is not limited to hardcopy printed pages, displayed on a screen, stored in a database or transmitted to a user through a network. This output information may be provided in terms of worker assignment by worker, worker assignment by work and any other acceptable structure which is selected or requested by the user.

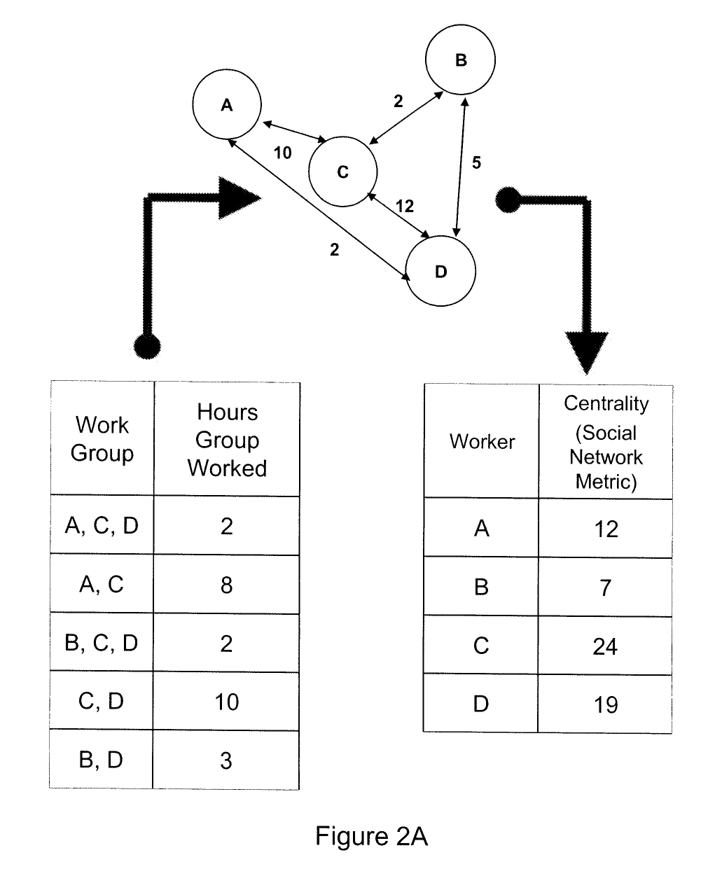

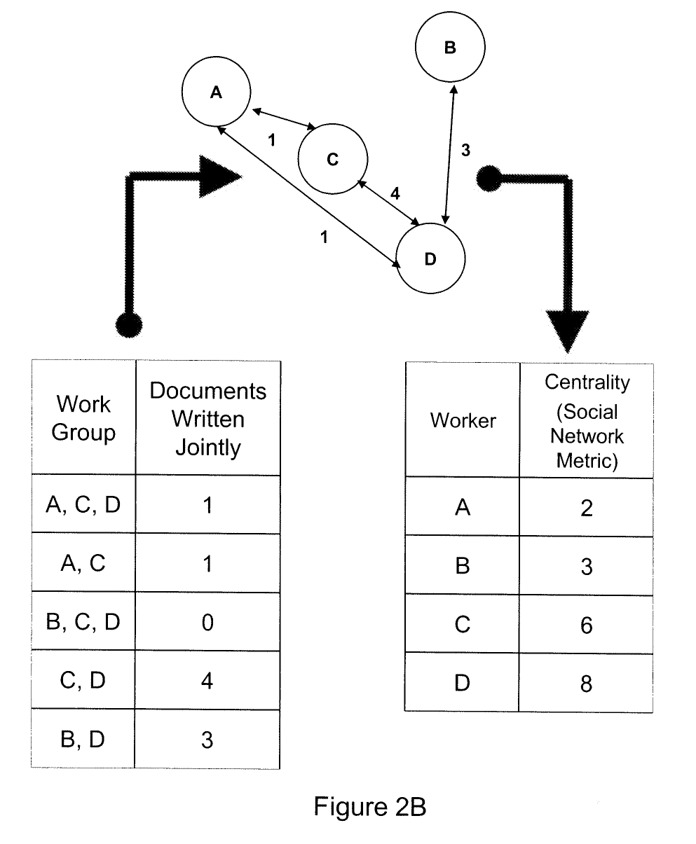

Another way to describe the invention is through an example that is shown in FIGS. 2-4. Referring to FIG. 2A, the steps of constructing the social network and applying metrics is shown. Preferably each of the steps is performed by computer using software stored on a medium which include instructions for each step FIG. 2A shows four workers (A, B, C, and D). The system has received inputs which can includes one or more of manual input, inputs read from a database, or data received electronically from some other network device or, for example, through a wired or wireless link. In this example, the input data defines the number of hours worked between pairs of users. The system performs a social network analysis using any one of a standard set of social network analytics and constructs the social network diagram. This diagram shows that worker A has worked 10 hours with worker C, worker A has worked 2 hours with worker D. The diagram shows that worker B has worked 2 hours with worker C and 5 hours with worker D, and so on. Using the topology of the constructed social network, the invention computes metrics for each worker and, in the case of the example, defines the metric in terms of general centrality. The central metric reflects that D worked the most number of hours directly with other workers. The centrality social network metric used in the example of FIG. 2A is the total number of hours worked directly with anyone in the network. This is the sum of numbers on the arcs of the social network topology connected to a given worker. Those skilled in the art would readily understand that numerous other computations are also possible.

FIG. 2A shows the centrality of worker C to be 24 which is higher than that of worker D (centrality metric of 19). This could be due to several reasons which are not specifically shown on the figure including, for example, worker D may have worked with each of the workers on multiple projects while worker C may have worked more hours but only on one common project to all three other workers. These types of parameters are considered when computing centrality or other metrics such as degree, betweenness, closeness, and flow centrality that are used in social network analyses, and the parameters which are considered in such calculations can vary depending on the application and needs of the user. Thus, in FIG. 2A, worker C is considered to have a higher centrality.

As a variation on the above, FIG. 2B shows construction of a social network where the number of documents written jointly is considered. A wide variety of criteria can be used when constructing a social network as is demonstrated by FIGS. 2A and 2B. Like FIG. 2A, FIG. 2B shows, for exemplary purposes, the centrality of worker D is higher.

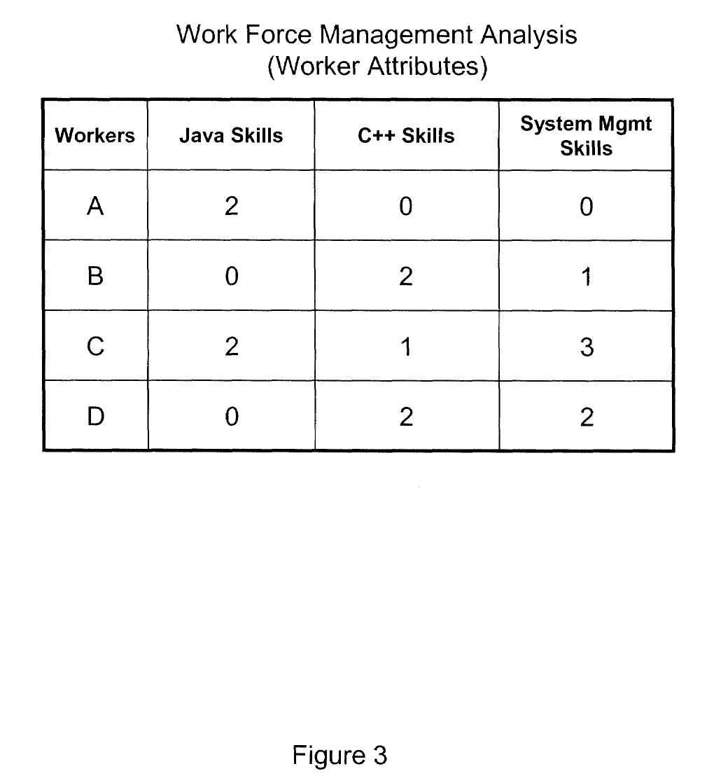

Turning now to FIG. 3, there is an example of some of the worker attribute data that would be available in the organization data base. These worker attributes are compiled using standard work force analysis techniques including, for example, manager assessment of mastery using a 4-level rating scheme, and a profile of each available worker is provided to the invention in terms of attributes.

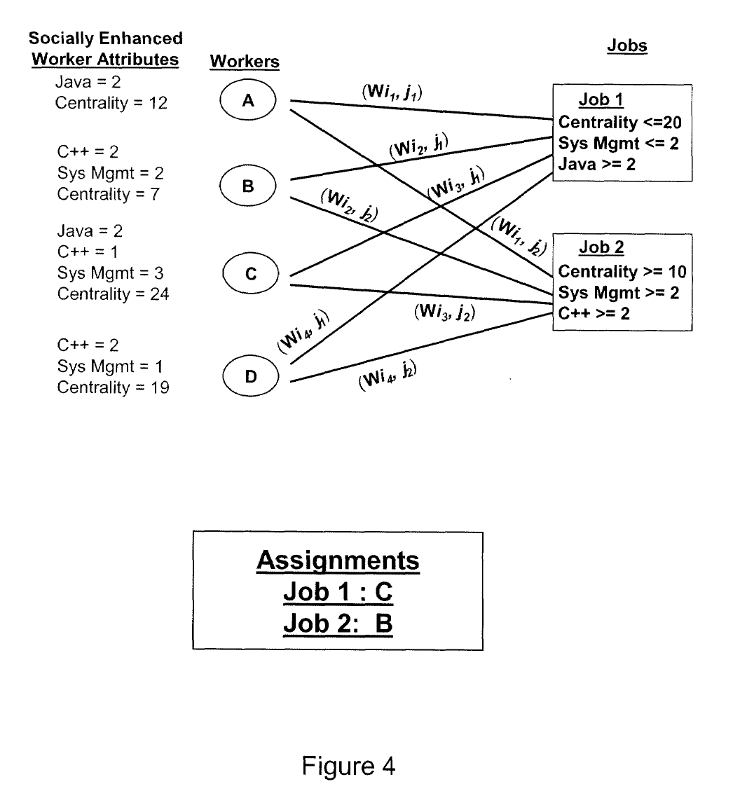

FIG. 4 shows the socially enhanced worker attributes as a combination of the computed social network metrics and the worker attributes. The requirements for each job (job 1 and job 2) are shown on the right hand side of FIG. 4. That is, Job 1 is defined as requiring a workers with system management skills less than or equal to 2, Java programming skills greater than or equal to 2 and centrality metrics less than or equal to 20. Similarly, Job 2 requires a centrality level greater than or equal to 10, system management skills greater than or equal to 2 and C++ skills greater than or equal to 2. Job requirements may be specified in a number of different ways, including but not limited to attributes, taxonomies, logical expressions, and constraints. As used herein, the term ‘attributes’, when referring to both ‘work attributes’ and ‘worker attributes’ includes one or more specified attributes, as well as any and all taxonomies, logical expressions, and constraints. From this data, the bipartite graph is built and the weights of each link are identified relative to how closely the worker at one of the links meets the requirements of the job at the other end of the link. In the example of FIG. 4, weight Wi₁,j₁ is much higher than the weight Wi₂,j₁ since job 1 requires Java programming capability which A has but B does not. The invention would continue to match the workers with the various jobs and apply weights to each of the links based on the socially enhanced worker attributes and the job requirements. Once all weights were applied, the system would recommend, as output, for example displayed on a computer screen or printed in a report, the work assignments that provide the highest confidence that the requirements are met relative to the weightings. These weights can also be influenced by direct user inputs that assigns maximum and minimum threshold.

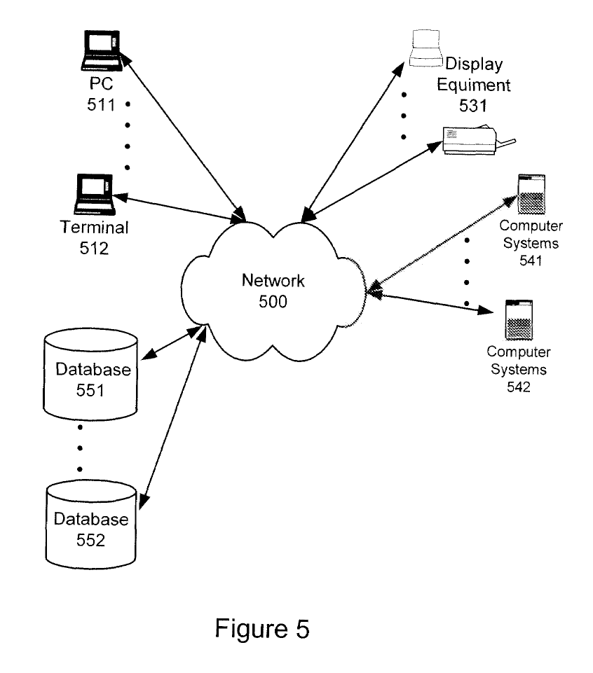

FIG. 5 provides a diagram of the type of computing resources that would be required to implement the invention. The configuration is shown as connecting computing resources through a network 500 but may also be a stand alone computer system configuration with processing capability, display capability, entry capability and storage capability. The network 500 shown in FIG. 5 may include but is not limited to a direct connection links between the computing resources, a local area network, and wide area network. Input data can be retrieved by the system from a single or multiple databases (551, 552). The data stored in these data bases can be centrally collected or distributed. Output of the invention may also be transmitted to and stored in one or all of these databases. The processing capability performed in system (541, 552) may be provided in any one of several configurations such as a standalone unit and multiple processing capabilities located throughout a network. The user may input data and receive data via terminals (511, 512) and display equipment 531. The display equipment and terminal may also be desktop computer systems or keyboard, printer and other input output devices.

While the invention has been described in terms of its preferred embodiments, those skilled in the art will recognize that the invention can be practiced with modification within the spirit and scope of the appended claims.

Having thus described our invention, what we claim as new and desire to secure by Letters Patent is as follows:

1. A computer implemented method for matching one or more people to one or more jobs using social network metrics, comprising the steps of:
obtaining data which describes available workers and required work in terms of worker attributes and work attributes;
constructing a social network based on one or more worker interactions using information obtained for said available workers in said obtaining step;
computing one or more metrics for said social network constructed in said constructing step;
using one or more metrics computed in said computing step in combination with one or more worker attributes obtained in said obtaining step to match one or more available workers to one or more required work using a bipartite graph matching process, and outputting a work assignment.

2. The computer implemented method of claim 1 wherein said one or more metrics computed in said computing step are selected from the group consisting of but not limited to centrality, degree, closeness, betweenness, network centrality, clustering coefficients, cohesion, density, radiality, reach, modularity, and flow centrality.

3. The computer implemented method of claim 1 wherein said obtaining data step provides
a list of workers, a work history for each worker, and worker attributes for each worker,
a list of required work and work attributes for each required work.

4. The computer implemented method of claim 1 wherein said using one or metrics step includes the steps of:
generating social network attributes for each worker;
combining social network attributes with worker attributes to generated socially enhanced worker attributes; and
using the socially enhanced worker attributes in said bipartite graph linking process.

5. A machine readable medium containing instructions for performing a method for matching one or more people to one or more jobs using social network metrics, said instructions coding for the steps of:
obtaining data which describes available workers and required work in terms of but not limited to worker attributes and in terms of but not limited work attributes;
constructing a social network based on one or more worker interactions using information obtained for said available workers in said obtaining step;
computing one or more metrics for said social network constructed in said constructing step;
using one or more metrics computed in said computing step in combination with one or more worker attributes obtained in said obtaining step to match one or more available workers to one or more required work using a bipartite graph matching process, and outputting a work assignment.

6. The machine readable medium of claim 5 wherein said one or more metrics computed in said computing step are selected from the group consisting of but not limited to centrality, degree, closeness, betweenness, network centrality, clustering coefficients, cohesion, density, radiality, reach, and modularity, and flow centrality

7. The machine readable medium of claim 5 wherein said instructions coding for using one or metrics includes instructions for performing the steps of:
generating social network attributes for each worker;
combining social network attributes with worker attributes to generated socially enhanced worker attributes; and
using the socially enhanced worker attributes in said bipartite graph linking process.

8. A system for matching one or more people to one or more jobs using social network metrics, comprising:
means for obtaining data which describes available workers and required work in terms of worker attributes and work attributes;
means for constructing a social network based on one or more worker interactions using information obtained for said available workers in said obtaining step;
a computer for computing one or more metrics for said social network constructed in said constructing step; and
a means for outputting a work assignment based on using one or more metrics computed by said computer in combination with one or more worker attributes to match one or more available workers to one or more required work assignments using bipartite graph linking processes.

9. The system of claim 8 wherein said one or more metrics computed by said computer are selected from the group consisting of but not limited to centrality, degree, closeness, betweenness, network centrality, clustering coefficients, cohesion, density, radiality, reach, and modularity, and flow centrality.

10. The system of claim 8 wherein said means for obtaining provides
a list of workers, a work history for each worker, and worker attributes for each worker,
a list of required work and work attributes for each required work.

11. The system of claim 8 wherein said means for outputting uses
a means for generating social network attributes for each worker;
a means for combining social network attributes with worker attributes to generated socially enhanced worker attributes; and
a means for using the socially enhanced worker attributes in said bipartite graph linking process.
